(19) United States
(12) Patent Application Publication
(10) Pub. No.: US 2010/0229197 A1
(43) Pub. Date: Sep. 9, 2010

(54) DIGITAL BROADCAST WIDGET SYSTEM

(75) Inventors: Chae-Yong Yi, Seoul (KR); Kyung-Ah Kim, Seoul (KR)

Correspondence Address: GREENBLUM & BERNSTEIN, P.L.C., 1950 ROLAND CLARKE PLACE, RESTON, VA, 20191, US

(73) Assignee: PXD, INC., Seoul (KR)

(21) Appl. No.: 12/682,942

(22) PCT Filed: Oct. 29, 2008
(86) PCT No.: PCT/KR2008/006389

§ 371 Date: Apr. 14, 2010

(30) Foreign Application Priority Data
Oct. 31, 2007 (KR) 10-2007-0110628

(51) Int. Cl. H04N 5/445; H04W 4/12

(52) U.S. Cl. 725/40; 455/466

(57) ABSTRACT

Provided is a digital broadcast (digital TV) widget system. The digital broadcast widget system includes: a transmitter for providing widget information for generating a widget and for providing one or more of broadcast information (A/V stream), EPG information, VOD information and Internet information for digital broadcast; a receiver for displaying the widget on a TV screen by processing the broadcast information (A/V stream), the EPG information, the VOD information, the Internet information and the widget information; and a user input unit for enabling a user to input to the receiver information responding to the widget. The receiver includes an application platform which having a browser for processing information provided from the transmitter or the user input unit and for generating the widget corresponding to the widget information, based on the broadcast information (A/V stream), the EPG information, the VOD information, the Internet information, and device information of the receiver.

### TECHNICAL FIELD

The present invention relates to a digital broadcast widget system (a digital TV widget system), and more particularly to a digital broadcast widget technology (a digital TV widget technology) which provides various interactive television services—1) interactive contents in synchronism with a specific TV program, and 2) independent service for everyday life information—in a widget form, and further provides interactions to users.

### BACKGROUND ART

In digital television environment, new functions are adopted which have not been used in prior television sets or set-top boxes by cable and satellite television providers. As broadcast system is digitalized, watchers expect new broadcast services with interactive television services.

In the prior digital television or set-top box, in order to transmit an interactive television service (digital data broadcasting), data for interactive contents related to specific TV program is transmitted being multiplexed into A/V (Audio/Video) stream and data for independent service unrelated to TV program, such as news, weather, traffic information, etc., is transmitted using a separate channel which is dedicated to digital data broadcasting only. In order to implement both interactive television services, a middleware (e.g., Open Cable Application Platform (OCAP)) is embedded on the set-top box, which renders problems of increase in system load as well as cost.

Further, in the prior art digital data broadcast, it is difficult to implement a TV program-specific content service using digital data with A/V stream. Furthermore, there are some usability issues as follows: data area for interactive service occupies too much screen only to interrupt watching TV or several depth of searching process is required for obtaining desired information.

### DISCLOSURE OF INVENTION

### Technical Problem

The purpose of the present invention is to provide a digital broadcast widget technology, i.e. a digital TV widget technology, which can variously use, through a widget, the interactive content service related to TV program or use the interactive TV service unrelated to the specific TV program.

Another purpose of the present invention is to provide a digital TV widget technology which provides a widget enabling an interaction between a transmission server and a user server so as to provide users desired information as well as watching TV.

Another purpose of the present invention is to provide a digital TV widget technology which enables user to modify setting options of the widget or to download new widget application through the Internet by providing a widget menu on a TV screen.

Another purpose of the present invention is to provide a digital TV widget technology which can connect, even though middleware is not embedded in the set-top box, to a widget site on the Internet server using a computer and can display widget information corresponding to the user information.

### Technical Solution

According to an aspect of the present invention, there is provided a digital broadcast widget system (a digital TV widget system), comprising: a transmitter for providing widget information for generating a widget application and for providing one or more of broadcast information (A/V stream), Electronic Program Guide (“EPG”) information, Video-On-Demand (“VOD”) information and Internet information for digital broadcast; a receiver for displaying the widget on a digital TV screen by processing the broadcast information (A/V stream), the EPG information, the VOD information, the Internet information and the widget information provided from the transmitter; and a user input unit for enabling a user to input to the receiver information responding to the widget.

In the digital TV widget system of the present invention, the receiver includes an application platform which having a browser for processing information provided from the transmitter or the user input unit and for generating the widget corresponding to the widget information, based on the broadcast information (A/V stream), the EPG information, the VOD information, the Internet information, and device information of the receiver.

In the digital TV widget system of the present invention, the user input unit inputs to the receiver user information including user ID and password, the receiver provides to the transmitter the inputted user information and unique number of the receiver, and the transmitter generates widget information corresponding to the user information and the unique number of the receiver, and provides the generated widget information to the receiver.

### ADVANTAGEOUS EFFECTS

According to the digital TV widget technology of the present invention, the user can conveniently use various useful information, while watching TV, by displaying various interactive contents related to TV program and various independent service for everyday life information on a TV display screen in a widget form.

According to the digital TV widget technology, information desired by the user can be searched and provided through a widget, while maintaining its security, by inputting specific user information through an interaction with the user.

According to the digital TV widget technology, since a widget responding to specific graphic symbol which is pre-embedded in a specific A/V stream can be provided, new business models can be created to the broadcast providers.

According to the digital TV widget technology, setting options for the widget can be modified using a widget menu, or new widget can be downloaded from a widget site on the Internet.

According to the digital TV widget technology, after connecting to the widget site on the Internet, it is possible to download widget information corresponding to the user information and set-top box unique number (ID) or modify the setting options of the widget.

### BRIEF DESCRIPTION OF DRAWINGS

FIG. 1 schematically illustrates a digital TV widget system according to the present invention.

FIG. 2 schematically illustrates a digital TV widget system according to the present invention.

FIG. 3 illustrates an embodiment of an on-screen widget and a tempo widget.

FIG. 4 illustrates an embodiment of a TV program-specific content widget.

FIG. 5 illustrates a channel bulletin board widget as an embodiment of the TV program-independent widget.

FIG. 6 illustrates a channel chatting widget as an embodiment of the TV program-independent widget.

FIG. 7 illustrates an embodiment of an Internet-type widget.

FIG. 8 is a flowchart illustrating a method for displaying a digital TV widget according to the present invention.

FIG. 9 is a flowchart illustrating a widget displaying method when detailed information is requested.

FIG. 10 is a flowchart illustrating a widget displaying method when user information is requested.

FIG. 11 illustrates controlling of widget location on a TV screen in the widget system according to the present invention.

FIG. 12 illustrates an embodiment of widget menu in the digital TV widget system according to the present invention.

### BEST MODE FOR CARRYING OUT THE INVENTION

Hereinafter, embodiments of the present invention will be described in detail with reference to the accompanying drawings.

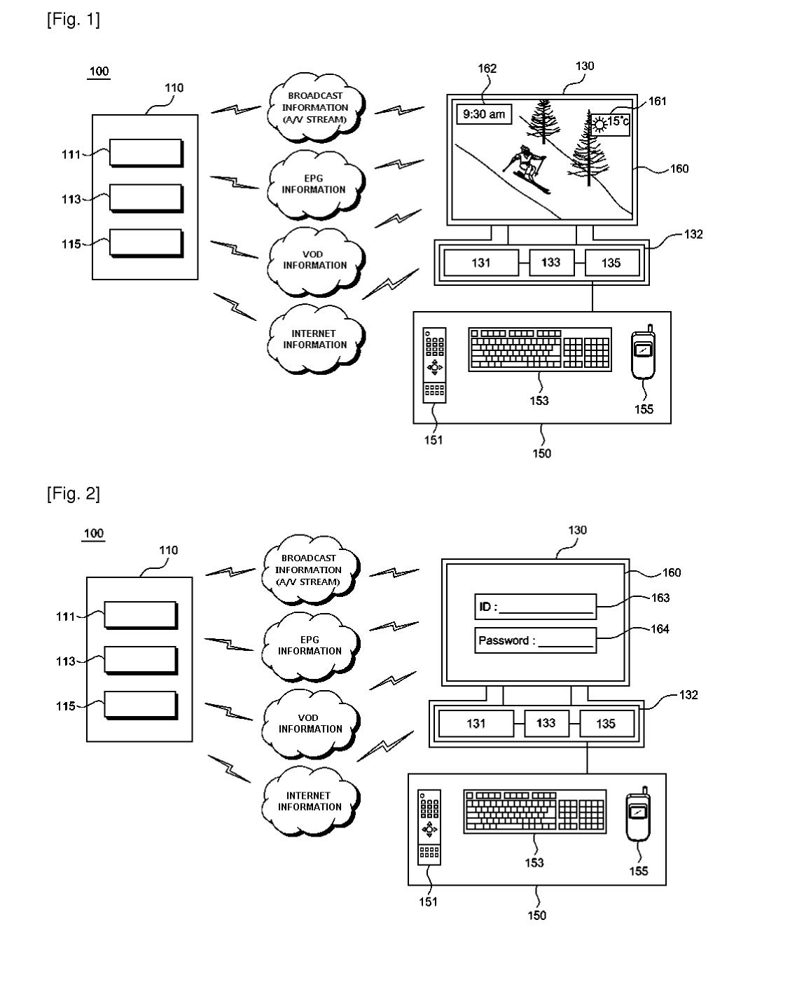

FIG. 1 illustrates a concept of a digital TV widget system according to an embodiment of the present invention. The digital TV widget system 100 includes a transmitter 110, a receiver 130, and a user input unit 150.

The transmitter 110 includes a broadcast server 111 transmitting A/V stream and EPG information for digital broadcasting, a media server 113 transmitting VOD information, and an internet server 115 transmitting Internet information. The transmitter 110 may further include a mobile communication server (not shown) which corresponds to request information inputted from the user input unit 150.

In general, the broadcast server 111 may be a terrestrial broadcasting station, a cable broadcasting station or a local broadcasting station. While analog broadcasting transmits TV programs produced by broadcasting stations unilaterally, digital broadcasting starts to provide an EPG service, an interactive guide for finding TV programs on a TV screen.

Electronic Program Guide (EPG) includes information on channels and TV programs, and further includes some functions such as reminding and recording reservation. With rapid development of additional functions, new business profit models for broadcast providers are being created.

Accordingly, the media server 113 provides contents desired by users at the time desired by users, by providing desired contents, so-called Pay-Per-View (PPV) or Video-On-Demand (VOD) services.

The Internet server 115 may include contents provider servers (i.e., google.com) and personal servers. The Internet server 115 takes an advantage of a digital interactive television so as to enable a web browsing service in digital broadcasting. By connecting the Internet server 115 and digital broadcasting, the user may use various Internet information in addition to watching TV programs on TV display screen.

The receiver 130 includes a demultiplexer 131, a decoder 133, and an application platform 132. The demultiplexer 131 is a module for demultiplexing A/V stream, EPG information, and VOD information. The decoder 133 is a module for changing encoded broadcast signal into a form that can be displayed on a television screen.

The application platform 132 includes a browser 135 which generates widgets 161 and 162 on a TV screen 160 out of the broadcast information (A/V stream), the EPG information, the VOD information, the Internet information and device information (not shown) embedded in the receiver and the transmitter. The receiver 130 may further include various applications for receiving signals from the transmitter 110 and the user input unit 150 so as to execute various processing.

The receiver 130 may be one or more of a digital set-top box, a television, a computer or a mobile communication terminal which may receives satellite broadcast, cable broadcast or terrestrial broadcast. A computer embedding a set-top box may be used as the receiver 130, then a keyboard or a mouse may be used as the user input unit 150. Although it is assumed herein that a middleware is not embedded on the receiver 130, the present invention is not limited thereto.

The browser 135 is a software application generally called a web browser. Through the browser 135, the user may upload texts, images, videos and musics or may interact with information in other webpages. The browser 135 generally uses HyperText Markup Language (HTML) or eXtensible Mark-up Language (XML) formats. Various widgets in the present invention are assumed to use the same format. The browser 135 may upload or download information to/from the Internet server 115 through HTTP.

Since users get through widgets various information used in computer webpages, the users can conveniently use the Internet in addition to watching TV. The ‘widget’ refers to a code set which may be installed or executed in a webpage without compilation. Examples of widget information which can be downloaded through the Internet include information of weather, traffic, stock, real-time search ranking, or the like. The kinds of the widget will be described below in detail.

The user input unit 150 is a device which enables user to input various widget information. The user input device 150 may be a remote control 151, a mobile communication terminal 155, and a user interface 153 such as a wired/wireless keyboard, a mouse, a touch screen or an on-screen keyboard.

The remote control 151 is an input device of a television. In order to use the widget, a widget enable function may be added to the existing function button and OK button, or a dedicated widget button is separately added. The widget appears on the TV screen 160 when the dedicated widget button is pressed, and disappears when the dedicated widget button is again pressed.

The user interface 153 is a tool for user inputs, and may be a wired keyboard, a wireless keyboard, a mouse, a touch screen, an on-screen keyboard, or the like. The keyboard is illustrated in FIG. 1. The user interface 153 provides a write function and thus can implement all functions used in a general computer. The user interface 153 may be used in a channel bulletin board widget or a channel chatting widget.

In addition to the remote control 151 and user interface 155 priorly used for televisions and computers, the mobile communication terminal 155 may be used as the user input unit 150. Digital broadcast functions or Internet functions are recently added to the mobile communication terminal 155, which renders various applications possible.

In the mobile communication terminal 155, by adding the digital broadcast function and Internet function to the function of providing user interactions through a communication network, a total service of three functions as above can be provided. The mobile communication terminal 155 can be configured to perform the functions of the receiver 130 as well as the user input unit 151, and preferably it can additionally perform the function of the transmitter 110 connected to the mobile communication server.

When a user inputs widget information through the user input unit 150, the digital TV widget system 100 according to the present invention selectively chooses various information provided from the transmitter 110 and displays in a widget format the information requested by the user on the digital TV screen 160 of the receiver 130.

FIG. 2 illustrates the widget system according to the present invention. In this embodiment, the widget system receives user information and widget information is configured so as to correspond to the user information.

When user information such as ID and password is inputted from the user input unit 150 through information screens 163 and 164, the receiver 130 transmits the user information to the transmitter 110 and receives the widget information which is interworking with the user information. The receiver 130 processes the widget information and displays the widget using the browser 135.

Let's assume that the receiver 130 includes a set-top box. When the set-top box is purchased and installed, user registration process is executed in a widget website by using an unique number. The unique number is normally issued by an unique number issuing function in a widget menu of the set-top box. User ID on the website can be interworked with the receiver 130 by providing the set-top box unique number after registering ID and password in user registration.

That is, after the server on the web connects to the receiver 130 by using the set-top box unique number, the synchronization is achieved by receiving the widget information installed in the current set-top box. Thereafter, when a setting option is changed in a widget on the web, a setting option of the widget of the receiver 130 is also changed. A new widget can be selected on the web and downloaded to other receiver 130.

This embodiment solves inconvenience in widget operation or widget downloading in the set-top box. This embodiment is to remove operating the set-top box, and to download widgets or change its configuration by connecting to the widget website using a computer.

This may be preferably adopted to download widget information by connecting to the widget website which requesting user information. The widget provider may make profit by operating the widget website interworking with user information, and may keep security of widget download by requesting the user information.

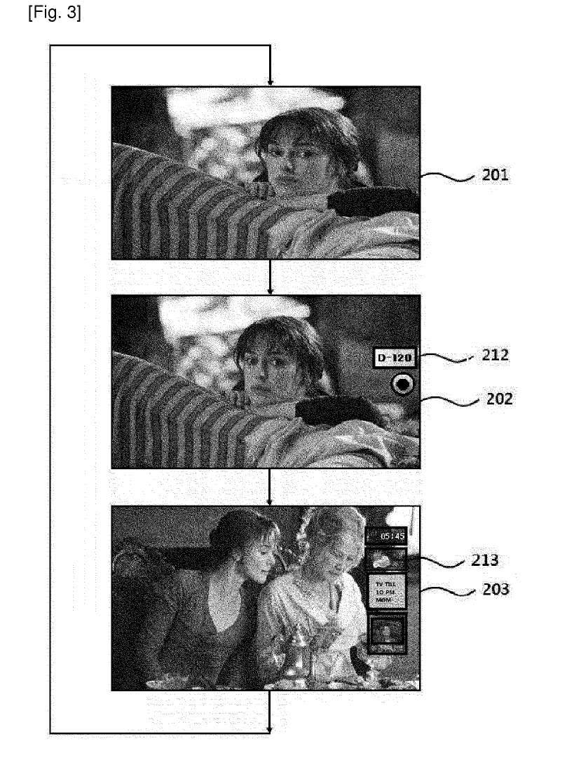

FIG. 3 illustrates an on-screen widget and a tempo widget, where the on-screen widget is continuously displayed on the TV screen and a tempo widget is temporarily displayed and then disappears, according to an embodiment of the present invention.

When a widget activation button, such as an [OK] button, a [EXIT] button or a dedicated widget button, is manipulated on a TV screen 201, the widget appears on the TV screen 201 so that it changes to a screen 202 where the widget 212 is provided.

Because widget 212 is a “D-120” anniversary countdown widget that corresponds to information which shall be always displayed without disturbing watching program, it is preferable to continue to display the widget 212 being uninfluenced by the power on/off or channel change operations. The configuring into on-screen widget can be achieved by pressing twice the widget button, like a toggle button, or by using the widget setup menu.

In case of a screen 203 displaying such a widget as today's weather widget, memo widget or preview widget (trailer) of a TV show, the widget information is effective only for a specific time duration and need not to be kept displayed. Therefore, it may be configured those widgets are displayed for a predetermined time such as 5 seconds or 30 seconds and then disappear. Such a widget 213 is a tempo widget.

The on-screen widget 212 and the tempo widget 213 can be variously configured regarding the contents and the displaying time according to the user's choice.

Other classification is also possible. For example, widgets may be classified into a TV program-specific content widget; a TV program-independent widget; an Internet-type widget which extracts widget information from Internet information; and a stand-alone widget which generates contents out of the receiver 130 itself such as clock and date widget.

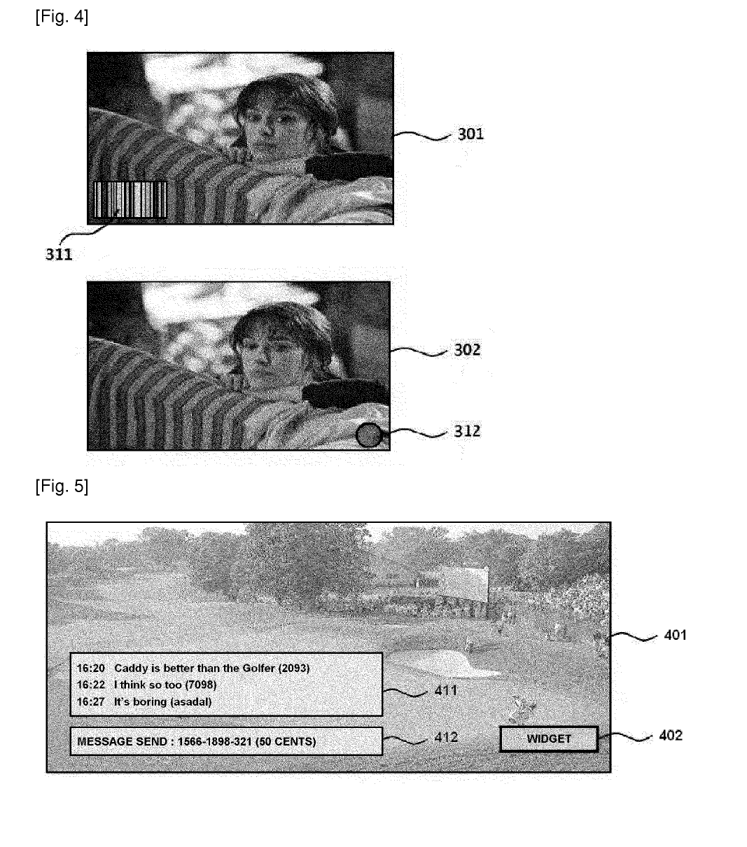

FIG. 4 illustrates the TV program-specific content widget according to an embodiment of the present invention.

Referring to the first screen, a barcode 311 appears on the left lower position of the TV screen 301. An advertisement provider inserts the barcode 311 into A/V stream of its sponsored TV program, and broadcasts and installs a widget responding to the barcode 311 in the receiver 130. Then, the receiver 130 may configure the widget to automatically perform a preset operation (e.g., the widget application is invoked and appears on a TV screen) when a TV program containing the barcode 311 is shown.

When the TV program containing the barcode 311 is received, the receiver 130 detects the information of the barcode 311 and obtains information on the current TV program from the EPG information. Then, the receiver 130 combines both information to automatically link to a specific webpage such that a widget containing related contents displays on the screen.

Referring to the second screen, a red graphic symbol 312 appears on the right lower position of the TV screen 302. Preferably, the red graphic symbol 312 is broadcast while being multiplexed into A/V stream signal, especially into video signal. For example, a widget responding to the preset red graphic symbol is installed in the receiver 130. Then, if the home shopping channel shows the pre-embedded red graphic symbol 312 hoping to use the widget, the widget being installed in the receiver 130 responds to automatically display a specific operation, e.g., a home shopping interactive application which can purchase the product.

Using TV program-specific content widget, the broadcast provider may make a new business model and the user may enjoy various services associated with the TV program. Examples of TV program-specific content widgets include a ‘recommendation-program’ widget, a ‘popular-program’ widget, a ‘reserved-program’ widget, and a ‘favorite-channel’ widget.

The TV program-specific content widgets 311 and 312 according to the digital TV widget system of the present invention will be described in more detail.

In the prior art, the TV program-specific content applications using middleware (e.g., Open Cable Application Platform (OCAP)) provide services by the steps as below.

In the transmitter 110, TV program (A/V stream) and interactive application are separately produced, and then A/V stream and application are multiplexed together so as to transmit. The receiver 130 in the set-top box, receiving the mixed signal, separates (demultiplexes) it into A/V stream and application. When a user presses a preset remote control button, the interactive application is executed.

However, in the prior art as above, it is difficult to produce interactive contents synchronized with the TV program due to such problems that much time and cost is required and producing the application in the transmitter 110 is troublesome. It is very difficult to produce even simple supplementary information. Due to those problems, although years have passed since digital broadcast has launched, data broadcast (interactive television service) is far from being satisfactory.

The TV program-specific content widget according to an embodiment of the present invention provides the service by the steps as below.

First, the transmitter 110 produces TV program and also produces a webpage and a widget for interactive television service. Then, the transmitter 110 inserts the barcode 311 into the A/V stream through for example a caption generator or inserts a special graphic symbol such as the red circle 312, and then transmits.

The receiver 130 demultiplexes the A/V stream and interactive application data. When the user presses a preset remote control button (e.g., widget button, OK button) in order to use widget service while watching TV program, the graphic symbol, such as barcode 311 or the red graphic circle 312 is detected. And the corresponding widget is displayed or the corresponding webpage is displayed through the browser. Preferably, the webpage may be displayed together with the TV program (A/V stream) on a TV screen at the same time.

The barcode 311 may include a URL. When the broadcast provider hopes to provide supplementary information for current broadcasting TV program, the supplementary information is provided through the webpage of the URL, without making special application for interactive service.

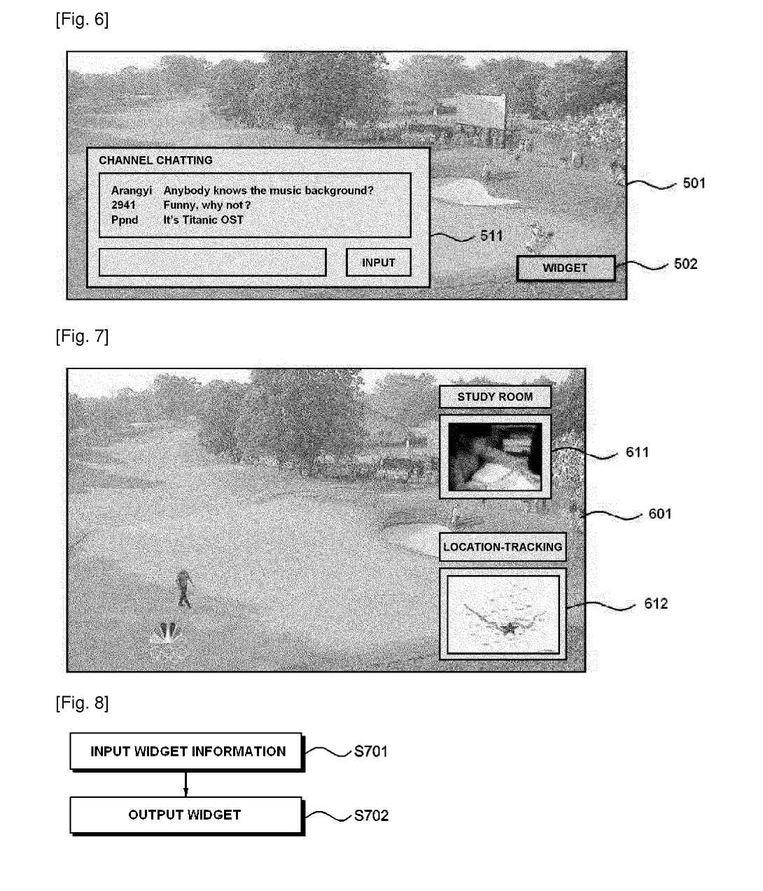

The TV program-independent widget is described with reference to FIGS. 5 and 6. FIG. 5 illustrates a channel bulletin board widget 411 as an embodiment of the TV program-independent widget. FIG. 6 illustrates a channel chatting widget 511 as an embodiment of the TV program-independent widget. The graphic design of channel bulletin board widget 411 and the channel chatting widget 511 is preferably designed with the optimal percentage of translucency to background video.

First, the channel bulletin board widget 411 is described with reference to FIG. 5.

While watching TV program 401, the channel bulletin board widget 411 can be displayed by clicking the widget menu 402 by the mouse or the touch screen, or by activating widget with the widget activation button of the remote control and then selecting the channel bulletin board in a widget menu.

In the channel bulletin board widget the user may write her/his opinions about current TV program by using the user input unit 150. Keyboard 153 or mobile communication terminal 155 may be used for the user input unit 150.

The receiver 130 stores the opinions in database and provides another user's receiver 130 who watches the same program and equally configures the channel bulletin board widget 411. Another user's receiver 130 displays the received contents on the channel bulletin board widget 411, and the user may also write on the channel bulletin board widget 411 in the same manner.

In addition, by further providing a function 412 of sending contents written on the channel bulletin board widget 411 in message form, the application platform 132 of the receiver 130 may transmit the message to the mobile communication terminal.

Next, the channel chatting widget 511 is described with reference to FIG. 6.

After the widget menu 502 is activated, the channel chatting widget 511 is invoked for a desired channel program. The receiver 130 drives a channel-relay database in the application platform 132 according to invoke command of the channel chatting widget 511. The channel-relay database contains a list of IDs whose invitations are accepted by the user in the channel chatting service.

Through those operations, messages the user writes in the channel chatting widget 511 is transmitted to another receiver 130 having an ID based on the channel-relay database, and the channel chatting data provided from another receiver 130 is received and the message is displayed on the channel chatting widget 511.

In the channel chatting widget 511 only users may participate who is having specific IDs for which invitations for chatting are accepted by the user, while the channel bulletin board widget 411 is open to all users who is watching the program.

TV program-independent widgets 411 and 511 according to the present invention are described in more detail.

During broadcasting, many people may think that specific scenes of the current drama are funny or bored. However, their opinions are not shared immediately. After the end of the TV program, the users share their opinions on the website. Accordingly, there is a need for service where opinions are shared in a form of the reply board 411 or the chatting 511 in realtime with TV programs.

Broadcast provider operates an Internet server 115 for channel bulletin board or channel chatting, as well as a broadcast server 111. Further, the broadcast provider connects an SMS reception server for enabling inputs from the mobile communication terminal, cell phone.

First, the channel bulletin board widget 411 is described. A user activates a channel bulletin board widget 411, then various opinions of other users for current TV program may be shown, or the user can directly participate in the widget by the following procedures.

In channel bulletin board widget 411 and channel chatting widget 511, the receiver 130 manages the database so as to directly transmit messages written by a user to other receivers 130, as described above. However, it is preferable that the message is relayed using the Internet server 115.

That is, for channel bulletin board widget 411, when a message is inputted using the user input unit 150, the message is transmitted to the Internet server 115 through HTTP, and the Internet server 115 transmits the message to the channel bulletin board widget 411 which is operating with respect to the current channel. Preferably, when the channel bulletin board widget 411 is activated, the information for the channel bulletin board is registered in the Internet server 115. Then, the Internet server 115 may check the channel bulletin board widget 411 operating in each channel, based on the registration information.

The channel bulletin board may permit an access from users connecting to the webpage through the computer, and may further permit an access of the bulletin board from users connecting to a WAP page through the mobile communication terminal 155.

In addition, for the channel chatting widget 511, the Internet server 115 may be configured to manage the relay database to properly relay the chatting messages transmitted from the receiver 130.

In adopting the mobile communication technology, special code numbers may be used. For example, special code numbers are allocated to broadcast channels, and SMS messages are transmitted over the special code numbers by using the mobile communication terminal 155 or computer. In this case, the text message is transmitted to the Internet server 115 through the SMS reception server which is allocated to the corresponding special code number, and the text message is transmitted to the channel bulletin board widget 411 for the corresponding channel.

Further, because many people are watching the channel bulletin board widget 411, it is preferable to adopting a technology for monitoring messages and deleting slangs etc. in the message. An automatic monitoring program may be installed in the Internet server 115 or the watchman may manually monitor the messages.

The channel bulletin board using widget is a method when the widget 411 is activated only when the user wants to participate. When the contents of the board are unsatisfactory, the user stops the widget 411 at any time so as to watch only TV program. Consequently, the user can select whether or not to watch the bulletin board. Accordingly, the channel bulletin board widget 411 may be adopted in a terrestrial broadcasting as well as cable broadcasting. When the service is provided over the terrestrial broadcasting, significant profit may be available.

The business model using channel bulletin board widget 411 is described below. In the channel bulletin board, up to five posted messages are displayed on the TV screen. Thus, a person who paying more money may be allowed higher priority, which lets her/his messages be exposed to the upper level for longer time. Further, viewing position or viewing duration may be sold as a paid placement.

Furthermore, the business model may allocate special code numbers to fan clubs or other specific communities, and operate the bulletin board widget 411 on the TV screen during the transmission of the related TV program of the channel. In this case, the contents of the bulletin board widget 411 can be managed where people may participate in the bulletin board through webpage using a computer.

Moreover, the channel bulletin board widget 411 and the channel chatting widget 511 may open the service to all users, or may open to among specific users. For example, the channel chatting widget 511 may be configured to provide conversation service with only intimate friends, not with all watchers. To achieving this, friends are invited based on IDs initially inputted or based on mobile numbers inputted when the chatting is started, and therefore the connection is allowed for a limited range.

FIG. 7 illustrates an embodiment of the Internet-type widget.

There are displayed a webcam widget 611 showing a study room and a location-tracking widget 612. The receiver 130 transmits a request signal to the Internet server 115 in response to information request for webcam widget 611 and location-tracking widget 612 inputted from the user input unit 150. The Internet server 115 provides to the receiver 130 some corresponding data, and displays webcam widget 611 and location-tracking widget 612.

A stock widget or weather widget may be classified as the Internet-type widget, seeing that they may be represented by searching information from the Internet server 115. In addition to those embodiments, any information requested by users can be provided as the Internet-type widget by searching it through the Internet.

As embodiments of the stand-alone widget, such widgets as a time widget, a anniversary countdown widget and a notepad widget are provided. The time widget 711, the anniversary countdown widget 712 and the notepad widget 713 are not associated with the broadcast information (A/V stream), and they need not search information from the Internet server. Further, they can be independently provided by using clock, anniversary countdown and notepad applications embedded in the receiver 130. The time widget (05:45) and the notepad widget (“TV till 10 pm, mom”) of FIG. 3 are embodiments of the stand-alone widget.

The Internet-type widgets 611 and 612 according to the present invention are described in more detail.

First, the webcam widget 611 is a small widget through which two users (users A and B) can transmit and receive moving pictures between them. The widget 611 of user A requests the connection to the widget 611 of user B through the Internet server 115. If user B accepts the connection request, users A and B can transmit and receive webcam pictures to and from each other through the webcam widget 611. Users may be identified by IDs, IPs, and phone numbers.

Assuming that user B has a computer in the study room where a webcam is connected hereto, the study room picture may be displayed on the screen of user A who is watching TV, as illustrated in FIG. 7. If user B uses a set-top box where a camera connected hereto, user A may watch user B remotely located, while watching TV.

Method of transmitting webcam picture is described. User B may transmit the image data by installing a client program optimized to a specific Internet server 115, or he may transmit webcam image data by using general-purpose webcasting software. The Internet server 115 may receive the webcam image data and retransmit it to user A.

The location-tracking widget 612 is described below. The location-tracking widget 612 may provide widget service in connection with a location-tracking system of a cell phone.

The widget of user A is connected to the location-tracking server of the mobile communication company through the Internet server 115. When the phone number of user B to be tracked is provided, the location-tracking server of the mobile communication company obtains the agreement of user B. The location-tracking server provides the location of user B to the Internet server 115, and displays the contents on a map through the widget 612 of user A. In this way, user A (e.g., housewife) may check her children or husband's location while watching TV.

FIG. 8 is a flowchart illustrating a digital TV widget displaying method according to the present invention.

According to the present invention, the widget displaying method includes a step of inputting information of desired widget to the receiver 130 through the user input unit 150 in the digital TV widget system (S701); and a step of displaying widget by driving browser 135 of application platform 132 out of the broadcast information (A/V stream), the EPG information, the VOD information, the Internet information, and the information on the devices of the receiver 130, which are provided from the transmitter 110 (S702).

The descriptions for the user input unit 150, the receiver 130, the transmitter 110 and the widget are already provided associated with the digital TV widget system.

The regular widget is extracted by the application platform 132 and displayed as a widget, based on the broadcast information (A/V stream), the EPG information, the VOD information, the Internet information, and the information on the devices of the receiver 130. However, it is preferable to include a process of checking whether the webcam information or the location-tracking information among the Internet information is permitted by the information holder.

FIG. 9 is a flowchart illustrating a widget displaying method when information inputted from the user input unit 150 requires detailed information.

When the widget information is inputted from the user input unit 150 (S801), the receiver 130 drives the application platform 132 to display the widget corresponding to the widget information inputted above.

The receiver 130 may invoke the widget menu on a TV screen in response to the input signal which is invoking the widget menu of the user input unit 150. The receiver 130 may receive information for executing commands on the menu. The commands may include widget configuration, widget modification, webcam and location-tracking, according to the selection of the user input unit 150.

When detailed information is required for displaying a widget, the application platform 132 further displays a widget for receiving the information and receives the detailed information from the user input unit 150 (S802). For example, the detailed information may be phone number for the location-tracking information and may be IP address for the webcam information.

The receiver 130 transmits the detailed information to the transmitter 110, i.e., the Internet server 115 or the mobile communication server. The transmitter 110 transmits the message for permission checking to the information holder, e.g., the mobile communication terminal to be tracked or a user web server of the webcam (S803).

When the information holder permits the information ('YES'), the information is transmitted to the receiver 130 (S804), such that the widget corresponding to the information is displayed (S805). On the contrary, when the information holder does not permit the information ('NO'), the widget indicating the access failure is displayed (S805).

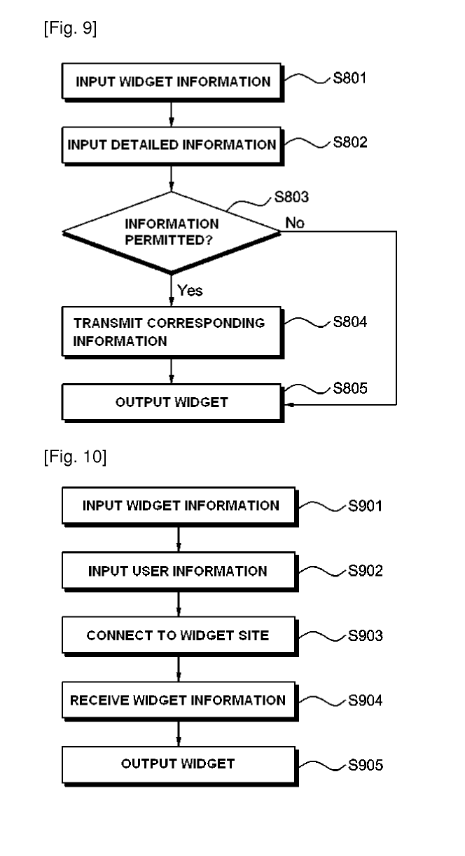

FIG. 10 is a flowchart illustrating a widget displaying method when information inputted from the user input unit 150 requires the user information.

The widget information is inputted to the receiver 130 by the user input unit 150 (S901). If the widget information requires user information, the receiver 130 displays a widget for acquiring the user information (S902), and connects to the Internet website to provide the user information and the widget information (S903).

The website authenticates the user information and transmits the widget information required by the user to the transmitter 130. The transmitter 130 receives the widget information (S904), and processes it to display the widget on a TV screen (S905).

By further inputting unique number of the receiver 130 as well as the user information, there may be displayed the widget information corresponding to the user information and the unique number. The widget information corresponding to the user information or the unique number may be new widget information or a value given by modifying a predetermined value of the widget already existing in the receiver 130.

When the receiver 130 is a set-top box, the digital TV widget displaying method may be performed as follows.

After the set-top box is purchased and installed, a set-top box unique number (e.g., an 8-digit number) is provided through a “unique number issuing” function in a set-top box widget menu. The user connects to the widget site through a computer, and sets the ID and password with the user information in the widget site. For user registration, the set-top box unique number is inputted so as to interwork ID along with the set-top box.

The web server connects to the user's set-top box by using the set-top box unique number, and then achieves the synchronization by receiving the widget information currently installed in the set-top box. When the user selects a widget and modifies its configurations in the website, the actual widget configuration of the set-top box is also modified. When a new widget is selected and downloaded in the website, the widget is downloaded to the set-top box.

In order to maintain the security of set-top box unique number, the set-top box unique number can be registered just once within 1 hour after issuing. Preferably, when the user inputs the new set-top box unique number, the old set-top box unique number is invalidated.

The widget displaying method through the authentication of the user information may make a profit to the provider, and may further ensure the security of the widget information through the authentication of the user information.

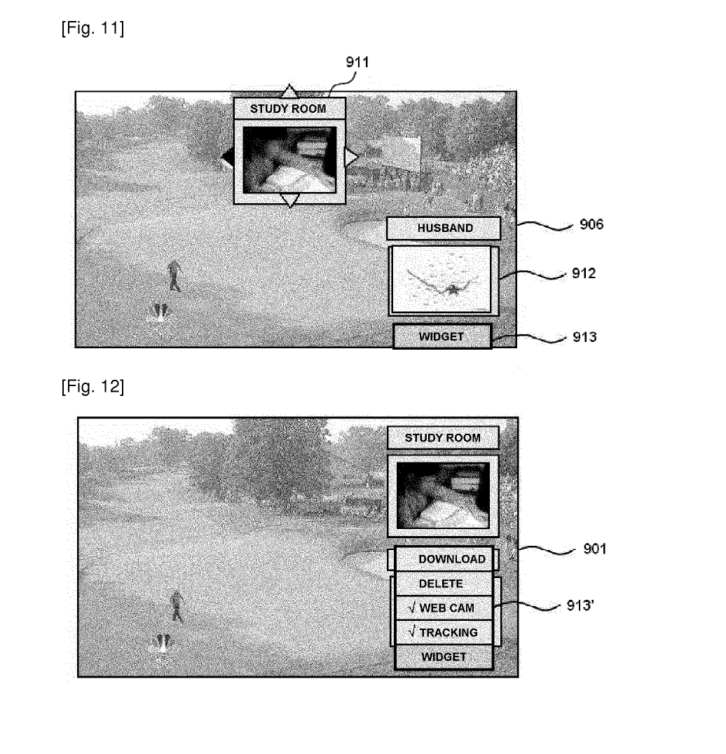

FIG. 11 illustrates the control of the widget position according to an embodiment of the present invention.

A webcam widget 911, a location-tracking widget 912 and a widget menu 913 are displayed from the upper portion of the screen 901. The focus is positioned at the widget menu 913. If the focus moves up by using the user input unit 150, the location-tracking widget 912 is activated. If the focus further moves up, the webcam widget 911 is activated.

Being the webcam widget 911 activated, if a function button invoking configuration widget such as OK button or ENTER button of the user input unit is clicked, then the configuration widget (not shown) is displayed. When a movement function of the configuration widget is enabled, the direction buttons, i.e., up/down/left/right buttons of the webcam widget 911 are displayed as illustrated in FIG. 11.

When the left direction button is enabled by the user input unit, the webcam widget 911 moves to the left as illustrated in the screen 906. If the direction button continues to be pressed, the movement speed may be set to be faster.

FIG. 12 illustrates a widget menu according to an embodiment of the present invention.

When the widget menu 913 is enabled, the expansion menu 913′ is provided as illustrated in FIG. 12. The expansion menu 913′ includes the widget download, deletion, webcam, location-tracking. The lower “widget” provides a function of moving to the upper menu. Preferably, any desired contents may be further added to the exemplary widget menu 913′. Preferably, the webcam or location-tracking contents may be deleted, or the name (Widget) of the widget menu 913′ may be modified.

The digital TV widget system according to the embodiments of the present invention provides various widgets related to the broadcasting and the everyday life information, such as the widget related to the TV program, the widget related to the Internet, and the widget related to the device itself, by using the browser. Thus, the user's convenience is improved by maximizing the interactive service of the digital broadcast, and new business model for making profits can be provided to the broadcast providers and the Internet providers.

1. A digital broadcast widget system, comprising:
a transmitter for providing widget information for generating a widget and for providing one or more of broadcast information (A/V stream), Electronic Program Guide (“EPG”) information, Video-On-Demand (“VOD”) information and Internet information for digital broadcast;
a receiver for displaying the widget on a TV screen by processing the broadcast information (A/V stream), the EPG information, the VOD information, the Internet information and the widget information provided from the transmitter; and
a user input unit for enabling a user to input to the receiver information responding to the widget,
wherein the receiver includes an application platform which having a browser for processing information provided from the transmitter or the user input unit and for generating the widget corresponding to the widget information, based on the broadcast information (A/V stream), the EPG information, the VOD information, the Internet information, and device information of the receiver.

2. The digital broadcast widget system of claim 1, wherein:
the user input unit inputs to the receiver user information including user ID and password;
the receiver provides to the transmitter the inputted user information and unique number of the receiver; and
the transmitter generates widget information corresponding to the user information and the unique number of the receiver, and provides the generated widget information to the receiver.

3. The digital broadcast widget system of claim 1, wherein:
the transmitter further provides a preset graphic symbol which is inserted to the broadcast information (A/V stream);
the widget is installed in the receiver so as to respond to the preset graphic symbol; and
the receiver executes the widget when the preset graphic symbol is detected on the TV screen.

4. The digital broadcast widget system of claim 3, wherein:
the transmitter provides a webpage corresponding to the preset graphic symbol; and
the receiver executes the widget responding to the preset graphic symbol and accesses and displays the webpage with the embedded browser.

5. The digital broadcast widget system of claim 1, wherein:
the transmitter comprises a channel bulletin board server providing a channel bulletin board for the broadcast information (A/V stream);
a channel bulletin board widget is installed in the receiver;
the receiver provides the channel bulletin board server with a message inputted on the channel bulletin board widget using the user input unit, and displays on a TV screen the board message information provided from the channel bulletin board server; and
the channel bulletin board server, when a message is provided from the channel bulletin board widget of the receiver, provides the message to the channel bulletin board widget being currently operating for the channel.

6. The digital broadcast widget system of claim 5, wherein:
the transmitter further comprises a Short Message Service (“SMS”) reception server for receiving SMS messages with respect to a preset special code number; and
the user input unit comprises a mobile communication terminal for transmitting a text message to the preset special code numbers.

7. The digital broadcast widget system of claim 5, wherein:
the channel bulletin board server separately manages users of higher priorities and exposes for longer duration at an upper position the messages provided from the users of higher priorities.

8. The digital broadcast widget system of claim 1, wherein:
the transmitter comprises a channel chatting server providing a channel chatting with respect to the broadcast information (A/V stream);
a channel chatting widget is installed in the receiver;
the receiver provides the channel chatting server with a message inputted on the channel chatting widget using the user input unit, and displays on the TV screen the channel chatting message information provided from the board server; and
the channel chatting server, having a list of user IDs for which invitations are accepted with respect to the channel chatting service for each channel, provides the message to the channel chatting widget according to the accepted user IDs when the message is received from the channel chatting widget of the receiver.

9. The digital broadcast widget system of claim 1, wherein:
the widget, being an Internet-type widget extracting widget information from the Internet information, comprises one or more of weather widget, stock information widget, traffic information widget, location-tracking widget, webcam widget, and internet search ranking widget.

10. The digital broadcast widget system of claim 1, wherein:
the widget, being a TV program-specific content widget corresponding to the broadcast information (A/V stream), the EPG information and the VOD information, comprises one or more of a recommendation-program widget, a popular-program widget, a reserved-program widget, and a favorite-channel widget.

11. The digital broadcast widget system of claim 2, wherein:
the transmitter further provides a preset graphic symbol which is inserted to the broadcast information (A/V stream);
the widget is installed in the receiver so as to respond to the preset graphic symbol; and
the receiver executes the widget when the preset graphic symbol is detected on the TV screen.

12. The digital broadcast widget system of claim 11, wherein:
the transmitter provides a webpage corresponding to the preset graphic symbol; and
the receiver executes the widget responding to the preset graphic symbol and accesses and displays the webpage with the embedded browser.

13. The digital broadcast widget system of claim 2, wherein:
the transmitter comprises a channel bulletin board server providing a channel bulletin board for the broadcast information (A/V stream);
a channel bulletin board widget is installed in the receiver;
the receiver provides the channel bulletin board server with a message inputted on the channel bulletin board widget using the user input unit, and displays on a TV screen the board message information provided from the channel bulletin board server; and
the channel bulletin board server, when a message is provided from the channel bulletin board widget of the receiver, provides the message to the channel bulletin board widget being currently operating for the channel.

14. The digital broadcast widget system of claim 13, wherein:
the transmitter further comprises a Short Message Service (“SMS”) reception server for receiving SMS messages with respect to a preset special code number; and
the user input unit comprises a mobile communication terminal for transmitting a text message to the preset special code numbers.

15. The digital broadcast widget system of claim 13, wherein:
the channel bulletin board server separately manages users of higher priorities and exposes for longer duration at an upper position the messages provided from the users of higher priorities.

16. The digital broadcast widget system of claim 2, wherein:
the transmitter comprises a channel chatting server providing a channel chatting with respect to the broadcast information (A/V stream);
a channel chatting widget is installed in the receiver;
the receiver provides the channel chatting server with a message inputted on the channel chatting widget using the user input unit, and displays on the TV screen the channel chatting message information provided from the board server; and
the channel chatting server, having a list of user IDs for which invitations are accepted with respect to the channel chatting service for each channel, provides the message to the channel chatting widget according to the accepted user IDs when the message is received from the channel chatting widget of the receiver.

17. The digital broadcast widget system of claim 2, wherein:
the widget, being an Internet-type widget extracting widget information from the Internet information, comprises one or more of weather widget, stock information widget, traffic information widget, location-tracking widget, webcam widget, and internet search ranking widget.

18. The digital broadcast widget system of claim 2, wherein:
the widget, being a TV program-specific content widget corresponding to the broadcast information (A/V stream), the EPG information and the VOD information, comprises one or more of a recommendation-program widget, a popular-program widget, a reserved-program widget, and a favorite-channel widget.
